(19) United States
(12) Patent Application Publication
(10) Pub. No.: US 2003/0234480 A1
(43) Pub. Date: Dec. 25, 2003

(54) Plank cramp and clamp assembly

(76) Inventor: Donald Harrison Thomas, Caloundra (AU)

Correspondence Address: ABELMAN, FRAYNE & SCHWAB, 150 East 42nd Street, New York, NY, 10017, US

(21) Appl. No.: 10/183,783

(22) Filed: Jun. 25, 2002

(51) Int. Cl. B25B 5/08

(52) U.S. Cl. 269/236

(57) ABSTRACT

A plank cramp (110) including:

an elongate member (111) adapted to support thereon in side-by-side abutting relationship two or more builders planks (139) or other articles to be cramped, said elongate member having retaining means (112) secured thereto at or adjacent one end adapted to engage with a side face and/or an upper face of the adjacent one of the planks to be clamped;

a clamp assembly (116) mounted on said elongate member for holding said two or more builders planks together on said elongate member, said clamp assembly including a gripping part having a passage therethrough and said elongate member passing slidably through said passage, and engagement means (119, 120) for engaging an upper face and a lower face of said elongate member for securing said clamp assembly in a predetermined desired position along said elongate member, and clamping means (124) operatively connected to said gripping part for pivoting movement towards and away from the upper face of said elongate member about a first pivot axis (126), and a cam (131) operatively connected to said gripping part for at least partial rotation relative thereto about a second pivot axis substantially parallel to said first pivot axis, said cam being adapted to engage said clamping means to force said clamping means into engagement with the upper face and/or the side face of the plank adjacent said clamp assembly to force the two or more planks to be cramped together and said engagement means into engagement with the upper and lower faces of said elongate member, and actuation means for actuating said cam.

THIS INVENTION relates to a plank cramp and a clamp assembly.

The invention has particular application to a plank cramp and a clamp assembly for use in cramping a plurality of aluminium builders planks together to form a platform. However, the plank cramp could be used with timber planks and could also have other applications such as a floor cramp, while the clamp assembly could be used with an L-shaped member as a slide clamp to provide an alternative to existing slide clamps or G-clamps.

While plank cramps are known, they typically are not as effective in use or as efficient to fit and, remove as desired.

The present invention aims to provide a plank cramp and a clamp assembly for a plank cramp which will be more effective and/or more efficient and/or safer than the presently available plank cramps and clamp assemblies.

With the foregoing in view, the present invention in one aspect resides broadly in a plank cramp including:

an elongate member adapted to support thereon in side-by-side abutting relationship two or more builders planks or other articles to be cramped; said elongate member having retaining means secured thereto at or adjacent one end adapted to engage with a side face and/or an upper face of the adjacent one of the planks to be clamped;

a clamp assembly mounted on said elongate member for holding said two or more builders planks together on said elongate member, said clamp assembly including a gripping part having a passage therethrough and said elongate member passing slidably through said passage, and engagement means for engaging an upper face and a lower face of said elongate member for securing said clamp assembly in a predetermined desired position along said elongate member, and clamping means operatively connected to said gripping part for pivoting movement towards and away from the upper face of said elongate member about a first pivot axis, and a cam operatively connected to said gripping part for at least partial rotation relative thereto about a second pivot axis substantially parallel to said first pivot axis, said cam being adapted to engage said clamping means to force said clamping means into engagement with the upper face and/or the side face of the plank adjacent said clamp assembly to force the two or more planks to be cramped together and said engagement means into engagement with the upper and lower faces of said elongate member, and actuation means for actuating said cam.

In another aspect the invention resides broadly in a clamp assembly including:

a gripping part having a passage for slidably receiving therethrough an elongate member, and engagement means for engaging an upper face and a lower face of the elongate member to which the gripping part is fitted to secure the clamp assembly in a predetermined desired position along the elongate member;

clamping means operatively connected to said gripping part for pivoting movement towards and away from the upper face of the elongate member about a first pivot axis;

a cam operatively connected to said gripping part for rotation relative thereto about a second pivot axis substantially parallel to said first pivot axis, said cam being adapted to engage said clamping means to force said clamping means into engagement with the upper face and/or the side face of a plank to be clamped and said engagement means into engagement with the upper and lower faces of the elongate member, and

actuation means for actuating said cam.

Terms such as upper, lower, side, top, base and the like are used for the purpose of description and illustration of the invention in the position it would normally be used in cramping builders planks together to form a platform and are not intended to limit the invention to use in any particular attitude.

Preferably said engagement means is constituted by spaced apart bars defining the upper and lower boundaries of said passage, said bars being also spaced apart in the direction along the elongate member on which the clamp assembly is mounted, and the upper bar being rearward of the lower bar and also rearward of the first pivot axis. Advantageously this arrangement allows the gripping part to pivot about the lower bar thereby forcing the upper bar into engagement with the upper face of the elongate member, while the lower bar engages with the lower face of the elongate member. It will be appreciated that as the cam forces the clamping means into engagement with the side face and/or the upper face of the adjacent plank, the reaction of the gripping part is to lift at its forward end thereby forcing the upper and lower bars into tight engagement with the elongate member.

Preferably the cam is shaped with a lobe for forcing the clamping means into engagement with the upper face and/or the side face of a plank followed by a dwell portion adapted to effectively lock the clamping means in the cramping position, the dwell portion preventing self release.

Preferably the clamping means is an L-shaped member which is pivotally mounted to the gripping part forward of the upper bar, the L being suitably sized and shaped to capture the upper edge of the plank in the enclosed corner of the L-shaped member. Suitably this shape allows the L-shaped member to force the plank downwardly onto the elongate member and also against the adjacent plank and so on to clamp against the retaining means at the other end of the elongate member.

In order that this invention may be more readily understood and put into practical effect, reference will now be made to the accompanying drawings which illustrate preferred embodiments of the invention and wherein:

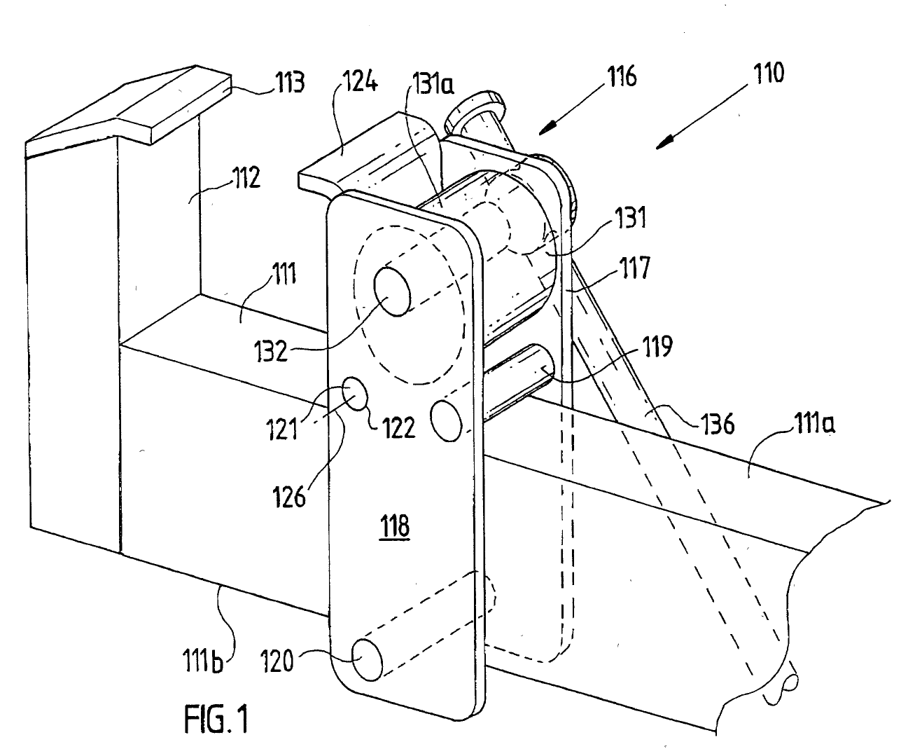

FIG. 1 is a pictorial representation of a plank cramp according to the invention;

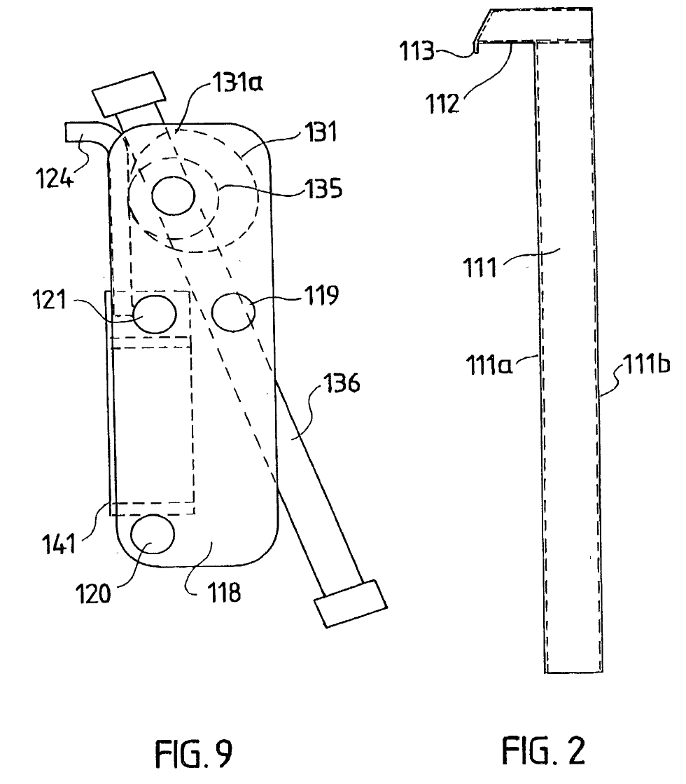

FIG. 2 is a side elevation of the elongate member of the plank cramp of FIG. 1;

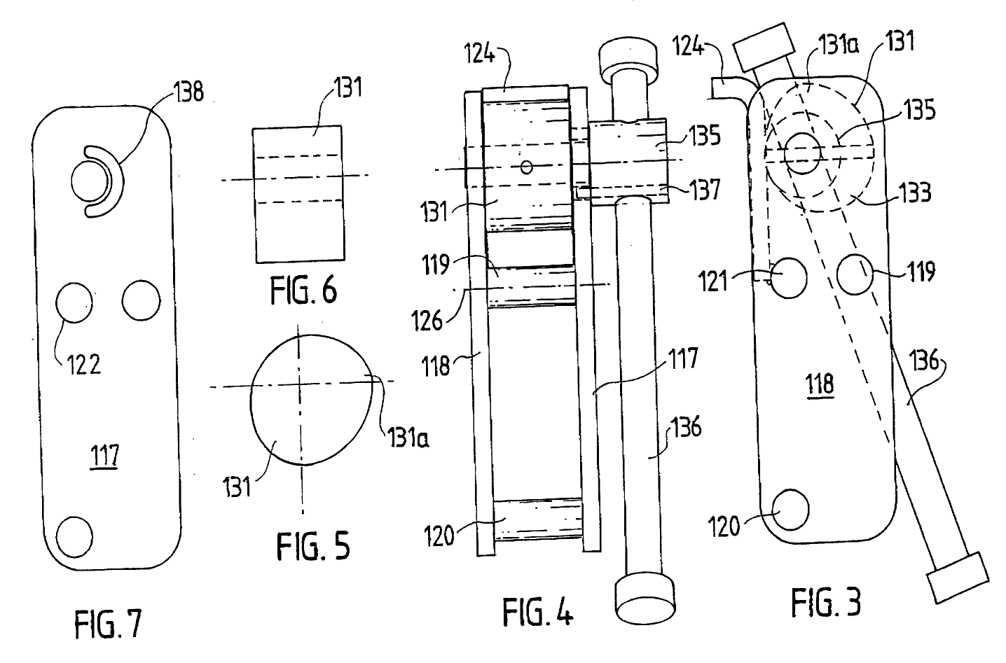

FIG. 3 is a side elevation of the clamp assembly of the plank cramp of FIG. 1;

FIG. 4 is a front elevation of the clamp assembly of FIG. 3;

FIG. 5 is a side elevation of the cam of the clamp assembly of FIG. 3;

FIG. 6 is a front elevation of the cam of FIG. 5;

FIG. 7 is a side elevation of one side plate of the clamp assembly of FIG. 3;

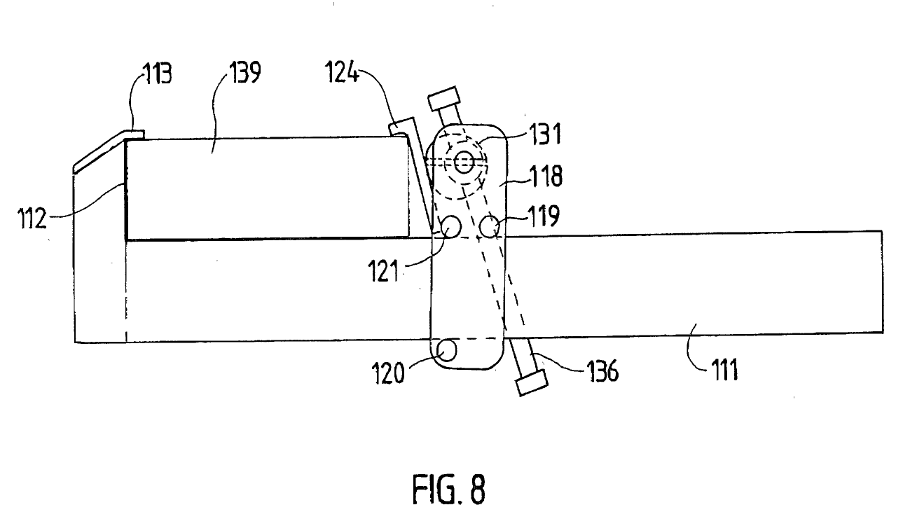

FIG. 8 is a side elevation of the plank cramp of FIG. 1 in use with one plank, and

FIG. 9 is a side elevation of an alternative clamp assembly according to the invention.

The plank cramp 10 illustrated in FIG. 1 includes an elongate member 111 constructed of 50 mm×25 mm×2 mm Rectangular Hollow Section(RHS) steel tube which has an end stop 112 welded thereto, the end stop being constructed of 30 mm×30 mm×2 mm RHS and having a top lug 113 extending towards the free end above the elongate member 111. The lug is spaced from the elongate member by a distance of approximately 51 mm so that a standard aluminium builders plank can be rested on the elongate member and retained or held thereto by the lug.

A clamp assembly 116 is mounted on the elongate member for sliding movement towards and away from the end stop. The assembly includes two side plates 117 and 118 which are spaced apart by a distance slightly greater than 25 mm so that the elongate member 111 can be received therebetween in a loose sliding fit. An upper bar 119 and a lower bar 120 extend between the side plates and are welded thereto to hold them in the desired spaced apart relationship.

A shaft 121 extends between the side plates directly forward of the upper bar 119 towards the end stop and is pivotally mounted in aligned apertures 122 and 123 provided therein respectively. An L-shaped tongue 124 is welded to the shaft so that it can pivot with the shaft about the shaft axis 126.

A cam 131 is mounted on another shaft 132 above and intermediate the upper bar and the shaft 121 and is arranged to engage with the tongue to cause it to pivot about the shaft axis 126 thereby moving it towards die end stop 112 and downwardly towards the upper face of the elongate member 111. The cam has a lobe portion 131a which defines the maximum movement of the tongue and a dwell portion 133 which prevents self release of the cam from the tongue. That is to say, once the cam reaches the maximum engagement position it can be rotated further in the dwell portion while maintaining the tongue in the same position. Full rotation of the cam against the tongue is prevented by a stop pin 137 which limits rotation of the cam shaft about its axis. The cam is actuated by the handle 136 which extends through an aperture provided in a protruding head 135 of the cam shaft The stop pin is a dowel which extends through the head of the cam shaft parallel to the shaft axis and engages in an arcuate slot 138 provided in side plate 117 as more clearly shown in FIG. 7.

In use, a plank or planks, preferably two, are rested on the upper face of the elongate member 111 with lug 113 extending just over an upper edge of the immediately adjacent plank, with the other plank being placed side by side the first plank. The clamp assembly 110 is then slid onto the elongate member with the short leg of the tongue 124 resting just over the upper edge of the second plank in a manner similar to that shown in FIG. 8 for the single plank 139. The cam is then rotated from the position shown in FIG. 1 and FIG. 3 through 180° to cramp the planks together by use of the handle 136. Under this action, as the tongue 124 pivots towards the end stop 112 and the upper face of the elongate member 111a,the rest of the clamp assembly lifts slightly so that the lower bar 120 engages with the lower face 111b of the elongate member and tilts slightly away from the end stop until the upper bar 119 engages with the upper face 111a and the elongate member is effectively gripped between the upper and lower bars. Continued rotation of the cam through the full 180° available effectively locks the tongue in place due to the dwell portion of the cam.

In order to release the planks, the cam is rotated through 180° in the opposite direction whereupon the clamp assembly can be moved away from the planks or even removed from the elongate member altogether.

The clamp assembly illustrated in FIG. 9 is very similar to the one previously described, except that instead of the passage through which the elongate shaft extends being defined by the upper and lower pins 119 and 120 and the two side plates 117 and 118, it is defined by a rectangular tubular portion 141 which is welded to the bottom pin 120 for pivoting movement about the axis of that pin, while the shaft 121 is mounted to the box section rather than the side plates. In this form of the invention, the upper pin 119 still grips the upper face of the elongate member but the lower wall of the tubular member 141 grips the lower face. In other respects the clamp assembly operates in much the same manner as that previously described.

While the foregoing description has been given by way of illustrative example of the invention, all modifications and variations thereto as would be apparent to persons skilled in the art are deemed to fall within the broad scope and ambit of the invention as defined in the appended claims.

The claims defining the invention are as follows:

1. A plank cramp including:
an elongate member adapted to support thereon in side-by-side abutting relationship two or more builders planks or other articles to be cramped, said elongate member having retaining means secured thereto at or adjacent one end adapted to engage with a side face and/or an upper face of the adjacent one of the planks to be clamped;
a clamp assembly mounted on said elongate member for holding said two or more builders planks together on said elongate member, said clamp assembly including a gripping part having a passage therethrough and said elongate member passing slidably through said passage, and engagement means for engaging an upper face and a lower face of said elongate member for securing said clamp assembly in a predetermined desired position along said elongate member, and clamping means operatively connected to said gripping part for pivoting movement towards and away from the upper face of said elongate member about a first pivot axis, and a cam operatively connected to said gripping part for at least partial rotation relative thereto about a second pivot axis substantially parallel to said first pivot axis, said cam being adapted to engage said clamping means to force said clamping means into engagement with the upper face and/or the side face of the plank adjacent said clamp assembly to force the two or more planks to be cramped together and said engagement means into engagement with the upper and lower faces of said elongate member, and actuation means for actuating said cam.

2. A plank cramp according to claim 1, wherein said engagement means is constituted by spaced apart bars defining at least in part the upper and lower boundaries of said passage, said bars being also spaced apart in the direction along said elongate member.

3. A plank cramp according to claim 2, wherein said gripping part is arranged to pivot about said lower bar thereby forcing said upper bar into engagement with the upper face of said elongate member while said lower bar engages with the lower face of said elongate member.

4. A plank cramp according to claim 3, wherein said upper bar is further from said retaining means than said lower bar and further from said retaining means than said first pivot axis.

5. A plank cramp according to claim 1, wherein said cam has a lobe for forcing said clamping means into engagement with the upper face and/or the side face of a plank followed by a dwell portion adapted to lock said clamping means in a cramping position in which the planks are cramped together.

6. A plank cramp according to claim 5, wherein said dwell portion is shaped to prevent self release of said cam.

7. A plank cramp according to claim 4, wherein said clamping means is an L-shaped member which is pivotally mounted to said gripping part between said upper bar and said retaining means, said L-shaped member being adapted to capture the upper edge of the plank in its enclosed corner.

8. A clamp assembly including:
a gripping part having a passage for slidably receiving therethrough an elongate member and engagement means for engaging an upper face and a lower face of the elongate member to which the gripping part is fitted to secure the clamp assembly in a predetermined desired position along the elongate member;
clamping means operatively connected to said gripping part for pivoting movement towards and away from the upper face of the elongate member about a first pivot axis;
a cam operatively connected to said gripping part for rotation relative thereto about a second pivot axis substantially parallel to said first pivot axis, said cam being adapted to engage said clamping means to force said clamping means into engagement with the upper face and/or the side face of a plank to be clamped and said engagement means into engagement with the upper and lower faces of the elongate member, and
actuation means for actuating said cam.

9. A clamp assembly according to claim 8, wherein said engagement means is constituted by spaced apart bars defining at least in part upper and lower boundaries of said passage, said bars being also spaced apart in the direction along said passage.

10. A clamp assembly according to claim 9, wherein, in use, said upper bar is vertically aligned with said first pivot axis.

11. A clamp assembly according to claim 10, wherein said cam has a lobe for forcing said clamping means into engagement with the upper face and/or the side face of a plank followed by a dwell portion adapted to lock said clamping means in a cramping position in which the planks are cramped together.

12. A clamp assembly according to claim 11, wherein said dwell portion is shaped to prevent self release of the cam.

13. A clamp assembly according to claim 11, wherein said clamping means is an L-shaped member with the free end of one leg being pivotally mounted to said gripping part for pivoting movement about said first pivot axis, said L-shaped member being adapted to capture the upper edge of the plank to be cramped in its enclosed corner.
